(19) United States
(12) Patent Application Publication
(10) Pub. No.: US 2022/0359944 A1
(43) Pub. Date: Nov. 10, 2022

(54) Vehicle Battery Holder

(71) Applicant: Etimex Technical Components GmbH, Rottenacker (DE)

(72) Inventor: Klaus HOLSTEIN, Laupheim (DE)

(73) Assignee: Etimex Technical Components GmbH, Rottenacker (DE)

(21) Appl. No.: 17/662,085

(22) Filed: May 5, 2022

(30) Foreign Application Priority Data
May 5, 2021 (DE) 10 2021 002 387.0

(51) Int. Cl. H01M 50/249; H01M 50/505

(52) U.S. Cl. CPC H01M 50/249; H01M 50/505; H01M 2220/20

(57) ABSTRACT

A motor vehicle battery support for contacting a plurality of battery cells has a base body made of plastics material and a bus bar made of metal which is fixedly mounted thereon. The base body is configured with a base surface for supporting the busbar on the base body. There is formed on the base surface at least one contour which protrudes from the base surface and is formed of the material of the base body and by means of which the busbar is held on the base surface by positive engagement and by means of which the busbar is at the same time allowed to expand lengthwise beneath the contour in the event of a temperature fluctuation.

### CROSS-REFERENCE TO RELATED APPLICATION

This application claims the benefit of German Patent Application No. 10 2021 002 387.0, filed May 5, 2021, the contents of which is incorporated by reference in its entirety.

### TECHNICAL FIELD

The disclosure relates to a motor vehicle battery support for contacting a plurality of battery cells, having a base body made of plastics material and a busbar made of metal which is fixedly mounted thereon.

### BACKGROUND

Wholly or partially electrically driven motor vehicles are known, in which the energy required for moving the motor vehicle is stored in batteries, which are also called accumulators or accumulator batteries, in the motor vehicle. For this purpose, battery supports, or battery trays/battery holders, are arranged in particular in the underfloor region of the motor vehicle for holding the batteries, which in some cases have a large mass and a large space requirement. The batteries are composed of a plurality of individual battery cells which are positioned and held in the battery support arranged side by side.

For the purpose of charging and discharging such batteries, electric cables are provided, which are to be guided to each of the individual battery cells and contacted therewith. For this purpose, busbars are conventionally arranged on the mentioned battery supports, from which busbars bond connections, in particular in the form bondwires, lead to the individual battery cells.

### SUMMARY

A goal of the disclosure is to provide a motor vehicle battery support such that the mentioned bond connections can be produced thereon inexpensively and at the same time reliably, and these bond connections also continue to be functionally reliable over the lifetime of the motor vehicle battery support.

This goal is achieved by a motor vehicle battery support for contacting a plurality of battery cells, having a base body made of plastics material and at least one busbar made of metal fixedly mounted thereon. The base body is configured with a base surface for supporting the busbar on the base body, and there is formed on the base surface at least one contour which protrudes from the base surface and is formed of the material of the base body and by means of which the busbar is held on the base surface by positive engagement and by means of which the busbar is at the same time allowed to expand lengthwise, in particular in the direction of its longitudinal extent, in the event of a temperature fluctuation.

With the solution according to the disclosure, a largely fixed arrangement of busbars on the base body is achieved. With this positionally accurate arrangement of the busbars on the base body, contact surfaces provided in particular on the at least one busbar for establishing the mentioned bond connections can be provided with the necessary spatial precision. The busbar is at the same time given sufficient freedom of movement by means of the mentioned contour that, in the event of temperature changes, the busbar, in conjunction with the adjacent base body, cannot deform the arrangement as a whole to an undesirably great extent. The permissible temperature changes are in particular in a range from at least −20° Celsius to at least +50° Celsius.

This freedom of movement of the busbars is achieved in particular in that the contour according to the invention retains the adjacent busbar by positive engagement in the direction towards the base body, that is to say substantially vertically relative to the base surface, whereas an expansion, or change in length, of the busbar is possible transverse to the base body, that is to say substantially parallel to the base surface. For this purpose, a contact surface formed between the contour and the busbar is particularly advantageously configured without the exertion of an adhering force and instead is configured solely with the exertion of a friction force. If the contour according to the invention nevertheless still exerts a certain adhering force on the busbar, this adhering force is preferably so small that it is lower than a shear force at the contact surface that occurs as a result of a change in length.

The busbars have in particular a length, or longitudinal extent, of at least 200 millimetres, in particular of at least 300 millimetres, and/or a width of at least 50 millimetres, in particular of at least 70 millimetres.

Correspondingly, the underlying goals is also achieved by a method for providing a motor vehicle battery support for contacting a plurality of battery cells, having a base body made of plastics material and at least one busbar made of metal which is fixedly mounted thereon. The method comprises the steps: producing a base surface for supporting the busbar on the base body, and forming on the base surface at least one contour which, protruding from the base surface, is formed of the material of the base body and by means of which the busbar is held on the base surface by positive engagement and by means of which the busbar is at the same time allowed to expand lengthwise, in particular in the direction of its longitudinal extent, beneath the contour in the event of a temperature fluctuation.

In an advantageous further development, the base body is produced by means of an injection-moulding process, in which the at least one busbar is inserted into an associated injection mould and the contour is then produced together with the base body. In such an injection-moulding operation, the busbar can be positioned accurately on the base body in only one process step and can at the same time be provided with the desired freedom of movement.

Alternatively, the material of which the contour is formed is advantageously provided together with the base body, but the contour itself is formed after the base body has been produced and after the busbar has been mounted on the base surface. In such a method, the base body can be produced first and then the at least one busbar can be mounted thereon in order to fix it there. The risk of rejects in production can thus be reduced. At the same time, the material for forming the contour can be “given” with the base body, whereby the process of forming the contour is simplified and can be made simpler and also more reliable in terms of manufacture.

Particularly preferably, the contour is in this case produced by means of hot shaping of the material provided together with the base body. Hot shaping is particularly advantageous for the subsequent forming of the contour according to the invention because, as a non-cutting process, it largely excludes in particular the risk of contamination at the workpiece.

Furthermore, a socket surface is in this case advantageously provided on the base body for application of a shaping tool for forming the contour. By means of the socket surface, a type of stop or abutment face can be provided for the shaping tool, on or onto which the tool can be moved during production. The shaping tool can thus be positioned accurately in particular also relative to the adjacent busbar in a particularly simple manner.

In a further alternative embodiment, the contour is produced together with the base body, and the busbar is pushed along the base surface beneath the contour. This procedure provides that the base body including the contour is first produced completely and then the busbar is mounted beneath the contour, namely by means of lateral sliding along the base surface. The busbar can thus be locked in place on the contour without elastic deformation, which is particularly reliable and positionally accurate. Abrasion at the contour during mounting can thus also be avoided. The busbar pushed beneath the contour is then in particular fixed in this end position, for which purpose a locking projection can be provided on the base body.

Furthermore, in the motor vehicle battery support, the contour is preferably in the form of an element which engages over the busbar in an edge region of the busbar. By means of the element which engages over the busbar, the busbar is held in the direction towards the base surface and can at the same time move at least slightly transversely thereto.

Alternatively, the contour is advantageously in the form of a bridge over the busbar. The bridge straddles the busbar and thus retains it particularly securely and permanently on the base surface.

In the motor vehicle battery support, the busbar is advantageously also in branched form with a plurality of arms, and at least one contour is formed on each of at least two of the arms, wherein in particular the at least one contour is formed in an end region of the associated arm. In particular, at least ten, preferably at least fifteen, such arms are provided on the busbar. The arms of adjacent busbars are in particular arranged branched relative to one another or meshing with one another.

Finally, in the motor vehicle battery support, the at least one busbar is preferably configured with a trunk and a plurality of arms, and at least one contour is formed on the trunk.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 is a plan view of an exemplary embodiment of a motor vehicle battery support.

FIG. 2 is a partial perspective view of an exemplary embodiment of a motor vehicle battery support produced by means of an injection-moulding process, in which a busbar has been removed.

FIG. 3 shows detail III according to FIG. 2.

FIG. 4 is a partial perspective view of an exemplary embodiment of a motor vehicle battery support produced by means of hot shaping.

FIG. 5 shows detail V according to FIG. 4.

FIG. 6 is a partial perspective view of an exemplary embodiment of a motor vehicle battery support produced by pushing a busbar.

FIG. 7 shows detail VII according to FIG. 6.

### DETAILED DESCRIPTION

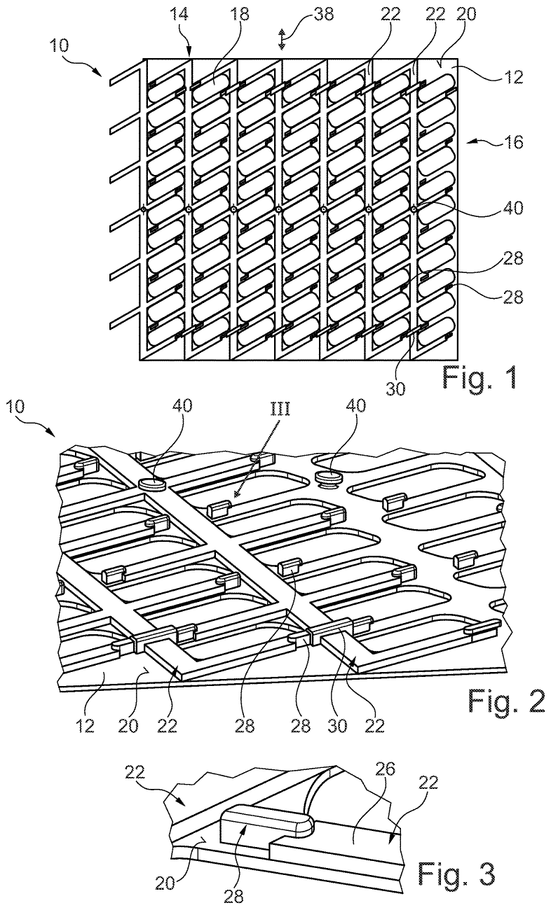

FIG. 1 shows a motor vehicle battery support 10 which is provided for contacting a plurality of battery cells, not shown in greater detail. The battery cells are located in rows beneath the motor vehicle battery support 10, which is here seen from above.

The motor vehicle battery support 10 is formed of a base body 12 which is produced from plastics material in the manner of a grid and has rod-shaped, flat longitudinal webs 14 and, oriented transverse and at the same time optionally slightly obliquely thereto, flat transverse webs 16, which are likewise rod-shaped.

Between the longitudinal webs 14 and the transverse webs 16 there are substantially elongate, oval-shaped through-openings 18, which extend through the base body 12, which is thus substantially flat.

Further components of geometric form for holding the mentioned battery cells can be located on the underside, not shown in greater detail, of the base body 12, but these components are not of further relevance here. The battery cells arranged there are contacted from the upper side, which is visible in FIG. 1, through the through-openings 18 by means of bondwires, which are likewise not shown here. For this purpose, the upper side of the base body 12 is in the form of a substantially planar base surface 20 on which a plurality of busbars 22 are mounted side by side and at the same time branching into one another.

The busbars 22 are produced from metal in the manner of a grid and are cut out in particular by means of punching or laser cutting. The busbars 22 each have a trunk 24, from which there protrude in each case a total of twelve arms 26, based on FIG. 1 six on the left and six on the right.

In order in particular that these arms 26 and also the trunk 24 are mounted on the base surface 20 securely and largely fixedly over the lifetime of the motor vehicle battery support 10, a plurality of contours 28 and 30 are formed on the base surface 20 for each busbar 22. By means of these contours 28 and 30, each busbar 22 is held by positive engagement on the base surface 20 and at the same time the busbar 22 is allowed to expand lengthwise beneath the contours 28 and 30 in the event of a temperature fluctuation.

The contours 28 are in the form of an element which engages over the busbar or in the form of a projection, while the contours 30 are in the form of a bridge which extends transversely over the associated busbar 22.

In the case of both forms of contours 28 and 30, there is in each case a contact surface 32 between the upper side of the busbar 22 in question and the underside of the contour 28 or 30. At this contact surface 32, the coupling between the busbar 22 perpendicular to the base surface 20 is based on positive engagement and transversely thereto, that is to say parallel to the base surface 20, it is in particular slightly force-based, such that a certain adhering force is still exerted. This adhering force is kept sufficiently small that it is lower than a shear force that occurs at the contact surface 32 as a result of a change in length of the busbar 22 in the event of a temperature change of in particular at least 20 Kelvin.

The contours 28 and 30 are formed of the material of the base body 12.

According to FIGS. 2 and 3, the base body has been produced by means of an injection-moulding process, in which the busbar 22 has been inserted into an associated injection mould, not shown here, and then the contours 28 and 30 have been injection moulded together with the base body 12.

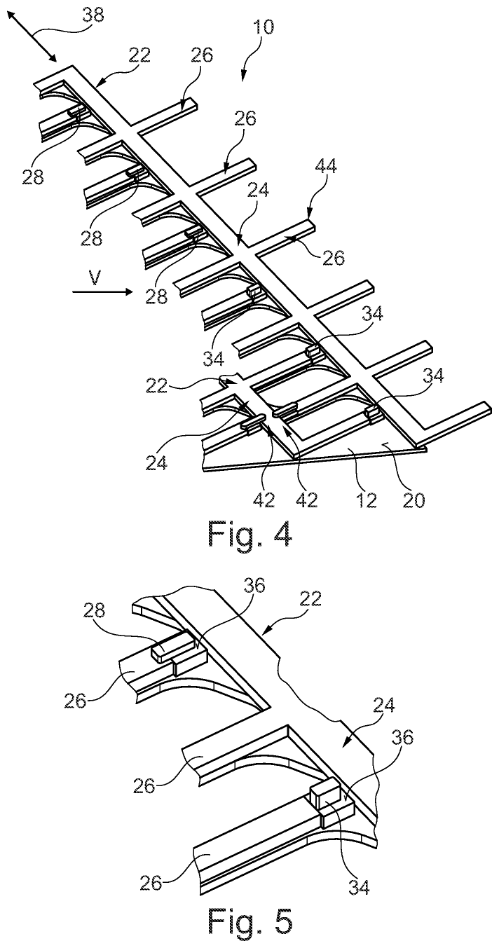

FIGS. 4 and 5 show an exemplary embodiment in which a material 34 of which the contours 28 have been formed has first been provided together with the base body 12. The busbars 22 have then been mounted on the base surface 20 and only then have the contours 28 themselves been formed on the base body 12 over the busbars 22 so mounted. The contours 28 have been produced by means of hot shaping from the material 34 provided together with the base body 12.

For this purpose, there has been formed on the base body 12 on the base surface 20, next to the later busbar 22, a socket surface 36 for the application of a shaping tool (not shown) for forming the contour 28.

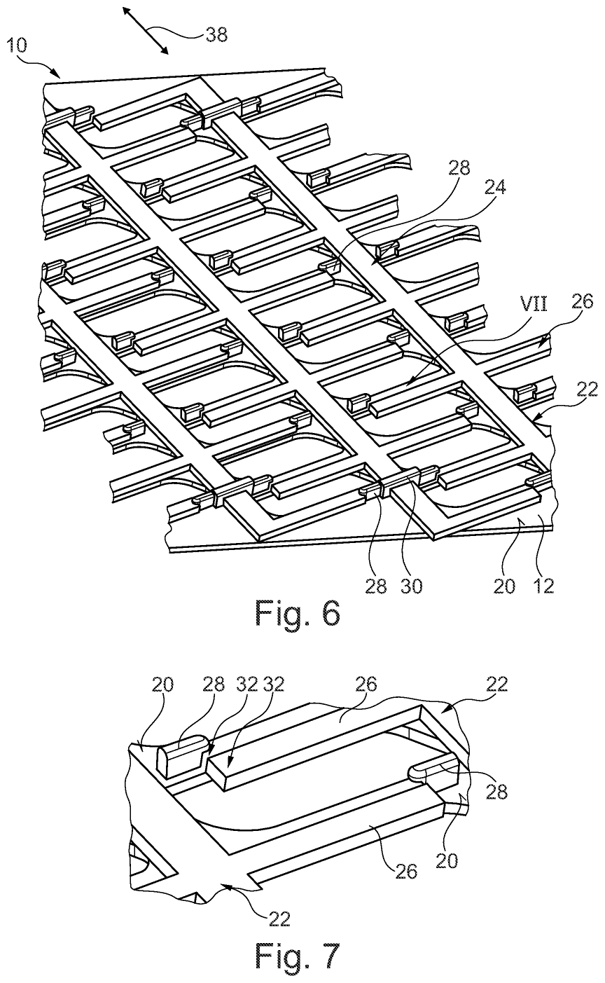

In the exemplary embodiment according to FIGS. 6 and 7, the contours 28 have been produced together with the base body 12, and the busbar 22 has subsequently been pushed along the base surface 20 beneath the contours 28. In this case, contours 30 in the form of bridges can be formed subsequently; they can be in the form of a locking means, or such bridges can also be dispensed with.

The trunks 24, each extending in particular in a longitudinal direction 38, of the busbars 22 are fixedly held substantially centrally by means of a pin 40 which protrudes perpendicularly from the base surface 20 and in particular extends through the respective trunk 24. At the same time, the mentioned contours 28 are formed in edge regions 42 of the trunk 24 and in end regions 44 of the arms 26 (see in particular FIG. 4). Lengthwise expansion of the busbars 22, in particular in the direction of their longitudinal direction 38, is thus allowed in the event of a temperature change.

Finally, it is noted that all the features which have been mentioned in the application documents and in particular in the dependent claims, despite the formal reference which has been made to one or more specific claims, are to be protected independently, individually or in any desired combination.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

### LIST OF REFERENCE NUMERALS

10 motor vehicle battery support

12 base body

14 longitudinal web

16 transverse web

18 through-opening

20 base surface

22 busbar

24 trunk

26 arm

28 contour in the form of an element which engages over a busbar

30 contour in the form of a bridge

32 contact surface

34 material

36 socket surface

38 longitudinal direction

40 pin

42 edge region

44 end region

What is claimed is:

1. A motor vehicle battery support (10) for contacting a plurality of battery cells, comprising:
a base body (12) made of a plastic material (34); and
a busbar (22) made of metal which is fixedly mounted on the base body (12),
wherein the base body (12) is configured with a base surface (20) for supporting the busbar (22) on the base body (12), and
wherein at least one contour (28, 30) is formed on the base surface (20),
wherein the at least one contour (28, 30) protrudes from the base surface (20) and is formed of the plastic material (34) of the base body (12),
wherein the busbar (22) is held on the base surface (20) by positive engagement with the at least one contour (28, 30), and
wherein the busbar (22) can expand lengthwise beneath the at least one contour (28, 30) in case of a temperature fluctuation.

2. The motor vehicle battery support according to claim 1,
wherein the at least one contour (28, 30) is an element which engages over the busbar (22) in an edge region (42) of the busbar (22).

3. The motor vehicle battery support according to claim 1,
wherein the at least one contour (30) is a bridge over the busbar (22).

4. The motor vehicle battery support according to claim 1,
wherein the busbar (22) is in branched form with a plurality of arms (26), and
wherein the at least one contour (28) is formed on each of at least two of the arms (26).

5. The motor vehicle battery support according to claim 1,
wherein the busbar (22) is configured with a trunk (24) and a plurality of arms (26), and
wherein the at least one contour (30) is formed on the trunk (24).

6. A method, comprising:
producing a motor vehicle battery support (10) comprising
a base body (12) made of a plastic material (34); and
a busbar (22) made of metal which is fixedly mounted on the base body (12),
wherein the base body (12) is configured with a base surface (20) for supporting the busbar (22) on the base body (12), and
wherein at least one contour (28, 30) is formed on the base surface (20),
wherein the at least one contour (28, 30) protrudes from the base surface (20) and is formed of the plastic material (34) of the base body (12),
wherein the busbar (22) is held on the base surface (20) by positive engagement with the at least one contour (28, 30), and
wherein the busbar (22) can expand lengthwise beneath the at least one contour (28, 30) in case of a temperature fluctuation.

7. The method according to claim 6,
wherein the base body (12) is produced by an injection-moulding process, in which the busbar (22) is inserted into an associated injection mould and the at least one contour (28, 30) is produced together with the base body (12).

8. The method according to claim 6,
wherein the plastic material (34) of which the at least one contour (28, 30) is formed is provided together with the base body (12), and
wherein the at least one contour (28, 30) is formed after the base body (12) has been produced and after the busbar (22) has been mounted on the base surface (20).

9. The method according to claim 8,
wherein the at least one contour (28, 30) is formed by hot shaping of the plastic material (34) provided together with the base body (12).

10. The method according to claim 8,
wherein a socket surface (36) is provided on the base body (12) for application of a shaping tool for forming the at least one contour (28, 30).

11. The method according to claim 6,
wherein the at least one contour (28, 30) is produced together with the base body (12), and
wherein the busbar (22) is pushed along the base surface (20) beneath the at least one contour (28, 30).
